(19) United States
(12) Patent Application Publication
(10) Pub. No.: US 2022/0156830 A1
(43) Pub. Date: May 19, 2022

(54) METHOD AND SYSTEM FOR TRANSMITTING INVESTMENT INFORMATION THROUGH AN INTERACTIVE WINDOW EMBEDDED IN A WEB PAGE

(71) Applicant: Chad Williams, Rosedale (CA)

(72) Inventor: Chad Williams, Rosedale (CA)

(21) Appl. No.: 17/527,697

(22) Filed: Nov. 16, 2021

Related U.S. Application Data
(60) Provisional application No. 63/114,206, filed on Nov. 16, 2020.

(51) Int. Cl. G06Q 40/04; G06F 16/957; G06F 16/958

(52) U.S. Cl. CPC G06Q 40/04; G06F 16/958; G06F 16/9577

(57) ABSTRACT

A computer-implemented method for collecting information via an interactive window embedded into a web page, the method comprising use a processing unit belonging to a server that further comprises at least a communication unit for transmitting and receiving data thereon for: providing a web page for display on a user display unit, the web page comprising an interactive window displaying a first message informing the user of an investment opportunity; receiving from the user a confirmation of an interest in the investment opportunity; updating the interactive window for displaying a second message requesting the user to select at least one type of securities; updating the interactive window for displaying a third message requesting the user to input a desired amount of financial resources to invest; receiving the desired amount of financial resources; updating the interactive window for displaying a fourth message requesting the user to input user information; receiving the user information; transmitting at least the received desired amount of financial resources and the received user information to an analyzer server being configured for information verification; receiving from the analyzer a confirmation of information compliance; and updating the interactive window for displaying a fifth message informing the user that a collection of information is complete.

### TECHNICAL FIELD

The present invention relates to the field of information transmission and investing in securities, and more particularly to methods and systems for transmitting information between securities issuers and investors via a website.

### BACKGROUND

Currently, when an investor decides to spend on a company's stocks or shares, a broker is usually involved to advise on the best practice. Such a broker is usually a person of good knowledge in the field of investment targeted by the investor and the advice given is valuable. More precisely, supplied with a mandate describing the risk assessment and the amount of financial resources (generally cash and/or margin) available for the investment, the broker will advise his client about solutions that are expected to maximize profits. From the point of view of the company issuing the stocks or shares, a broker may be solicited to find investors whose profiles match their financial situation. Consequently, the downside of using a broker in such a transaction resides in resource consumption, such as time or currency. This could be bypassed by modern solutions. One can think of using automated software that mimics the role of a broker by advising investment solutions depending on an investor's profile based on predetermined financial models. While such software exists, allocated resources for the investment process can still be lowered by other strategies.

Therefore, there is a need for an improved method and system for transmitting investment information and purchasing securities directly from a securities issuer in order to increase efficiency and minimize transaction costs.

### SUMMARY

In accordance with a first broad aspect, there is provided a computer implemented method for collecting information via an interactive window embedded into a web page, the method comprising use a processing unit belonging to a server that further comprises at least a communication unit for transmitting and receiving data thereon for: providing a web page for display on a user display unit, the web page comprising an interactive window displaying a first message informing the user of an investment opportunity; receiving from the user a confirmation of an interest in the investment opportunity; updating the interactive window for displaying a second message requesting the user to select at least one type of securities; updating the interactive window for displaying a third message requesting the user to input a desired amount of financial resources to invest; receiving the desired amount of financial resources; updating the interactive window for displaying a fourth message requesting the user to input user information; receiving the user information; transmitting at least the received desired amount of financial resources and the received user information to an analyzer server being configured for information verification; receiving from the analyzer a confirmation of information compliance; and updating the interactive window for displaying a fifth message informing the user that a collection of information is complete.

In accordance with another broad aspect, there is provided a system for collecting information via an interactive window embedded into a web page, the system comprising: an issuer server configured for generating a web page comprising an interactive window embedded therein, the server being further configured for: providing a web page for display on a user display unit, the web page comprising an interactive window displaying a first message informing the user of an investment opportunity; receiving from the user a confirmation of an interest in the investment opportunity; updating the interactive window for displaying a second message requesting the user to select at least one type of securities; updating the interactive window for displaying a third message requesting the user to input a desired amount of financial resources to invest; receiving the desired amount of financial resources; updating the interactive window for displaying a fourth message requesting the user to input user information; receiving the user information; transmitting at least the received desired amount of financial resources and the received user information; and an analyzer server configured for: receiving the at least the received desired amount of financial resources and the received user information; determining whether the at least the received desired amount of financial resources and the received user information are compliant with a set of predefined rules, thereby obtaining an analysis result; and transmitting the analysis result to the issuer server, wherein the issuer server is further configured for updating the interactive window for displaying a sixth message informing the user that a collection of information is complete when the analysis result indicates that the received desired amount of financial resources and the received user information are compliant with the set of predefined rules.

In accordance with another broad aspect, there is provided a computer-implemented method for purchasing securities issued by an issuer by collecting information from a user via an interactive window embedded into a web page. A web page is provided for display on a user display unit. The web page includes an interactive window displaying a first message informing the user of an investment opportunity to purchase securities issued by the issuer. A confirmation of interest in the investment opportunity is received from the user. The interactive window is updated to display a second message requesting the user to select a type of securities that the user wishes to purchase. A selection of the type of securities that the user wishes to purchase is received from the user. The interactive window is updated to display a third message requesting the user to input a desired amount of financial resources to invest. An indication of the desired amount of financial resources is then received from the user. The interactive window is updated to display a fourth message requesting the user to input user information identifying the user and specifying a method of payment, and the user information is then received. At least the received indication of the desired amount of financial resources, the selected type of securities, and the user information is transmitted to an analyzer server, the analyzer server being configured for information verification. A confirmation of information compliance in then received from the analyzer server. The indication of the desired amount of financial resources, the selected type of securities, and the user information is then sent to the issuer via an electronic network, and the issuer determines whether to redirect the user to purchase the securities from an exchange or sell the securities directly, by the issuer, to the user. Either (a) the securities are obtained on behalf of the user, by the issuer, from the issuer's treasury, and the issuer informs the user that the securities have been purchased, or (b) the user is redirected to a website configured to permit the user to purchase the securities via the exchange.

### BRIEF DESCRIPTION OF THE DRAWINGS

FIG. 1 is a flow chart illustrating a method for sending a user's personal information and investment criteria to an external server, in accordance with an embodiment.

FIG. 2 illustrates an exemplary web page comprising an interactive window offering an opportunity for investment by a user.

FIG. 3 illustrates the exemplary web page of FIG. 2 in which the interactive window requests the user to select desired securities.

FIG. 4 illustrates the exemplary web page of FIG. 2 in which the interactive window requests the user to input an investment amount of money.

FIG. 5 illustrates the exemplary web page of FIG. 2 in which the interactive window requests the user to input contact information.

FIG. 6 illustrates the exemplary web page of FIG. 2 in which the interactive window notifies the user that the transmission of the information has been successful.

FIG. 7 illustrates the exemplary web page of FIG. 2 in which the interactive window informs the user that his provided information is protected.

FIG. 8 illustrates the exemplary web page of FIG. 2 in which the interactive window informs the user that there is no commitment to purchase.

FIG. 9 depicts a schematic diagram of an electronic device in accordance with one or more non-limiting embodiments of the present technology.

FIG. 10 is a block diagram illustrating an investment information system between an issuer and an investor, in accordance with an embodiment.

FIG. 11 depicts an electronic device suitable for use with some implementations of the present technology.

### DETAILED DESCRIPTION

Bypassing a broker during investment procedures is a strategy typically adopted by investors for saving resources and simplifying steps. For transactions that are not complex enough to require the use of a broker, investors typically turn towards the use of software for receiving financial advice and purchasing securities via an exchange. For some, even the use of software based on pre-established financial patterns can be inconvenient or inaccessible. Typically, a certain amount of knowledge in the field of investment software is needed for the practice and the amount of resources to be spent can still be high. An approach that directly gives advice and allows purchase of securities when an investor is interested in investing in a particular company, with substantially no cost nor needed investment knowledge, is clearly of interest in the field.

In the following there is described a method and system for transmission of information between investors and issuers that allow to overcome at least some of the inconveniences described above.

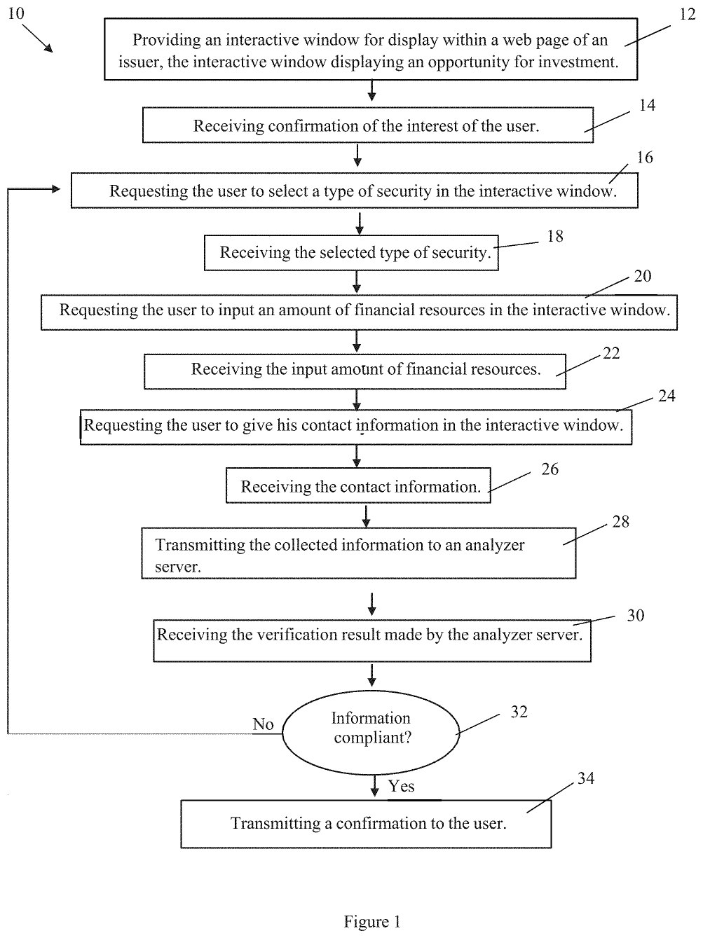

FIG. 1 illustrates one embodiment of a method 10 for collecting information about a user such as a potential investor interested in a potential investment in a company hereinafter referred to as the issuer that issues securities, such as shares in the company and bonds. The method 10 is implemented by a computer system with at least one processor, a memory and a communication interface, such as a server.

At step 12, a server of an issuer, or of a third party provider operating the server on behalf of the issuer, transmits a web page comprising an interactive window to a computer of a user. It should be understood that the server of the issuer and the computer of the user are connected via a communication network, such as the internet. The transmission of the web page follows the reception of a request for the web page from the user's computer. The request is received from the computer of the user after the user enters the Uniform Resource Locator (URL) corresponding to the web page into his or her browser. The web page may be the home page of the website of the issuer, for example. However, it should be understood that the web page comprising the interactive window may be any other adequate web page from the website of the issuer, or of a third party provider acting on behalf of the issuer.

In one embodiment, the interactive window is inserted into the requested web page. In another embodiment, the requested web page comprises no interactive window. In this case, the method 10 comprises a step of embedding the interactive window within the requested web page at a predefined location therein.

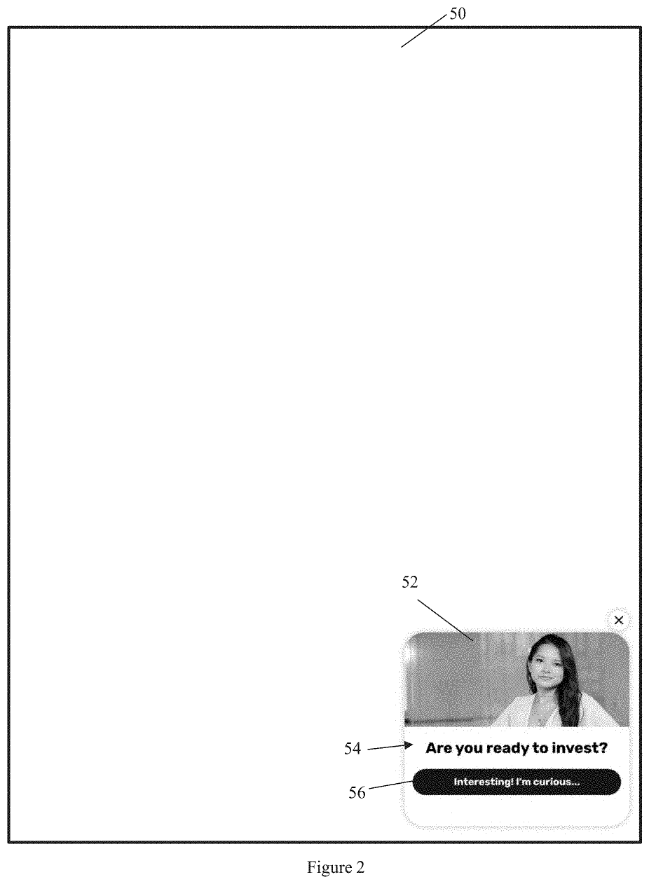

FIG. 2 illustrates an exemplary web page 50 comprising an interactive window 52. In the web page 50, the interactive window 52 is located at the bottom right. However, a person skilled in the art will understand that the location of the interactive window 52 is exemplary only. In the illustrated embodiment, the interactive window comprises text 54 informing the user of an investment opportunity and a button 56. If the user is interested in the proposed investment or simply desires to receive information about the investment, the user activates the button 56 located within the interactive window. The activation of the button 56 triggers the emission of a signal indicative of the triggering of the button by the user's computer to the issuer server.

At step 14, the signal indicative of the triggering of the button is received by the issuer server which interprets the reception of the signal as a confirmation of the user's interest in the investment.

Following the reception of the confirmation of the interest of the user, the user is requested to select a type of security at step 16. To do so, the issuer server transmits the type of securities available for purchase to the computer of the user. In one embodiment, only the interactive window is modified within the web page displayed to the user. In this case, only the information contained within the interactive window is updated. In another embodiment, the whole web page is modified, i.e. a new web page comprising the interactive window is transmitted by the issuer server to the user computer over the communication network. In both cases, information relative to the securities available for purchase is contained in the interactive window.

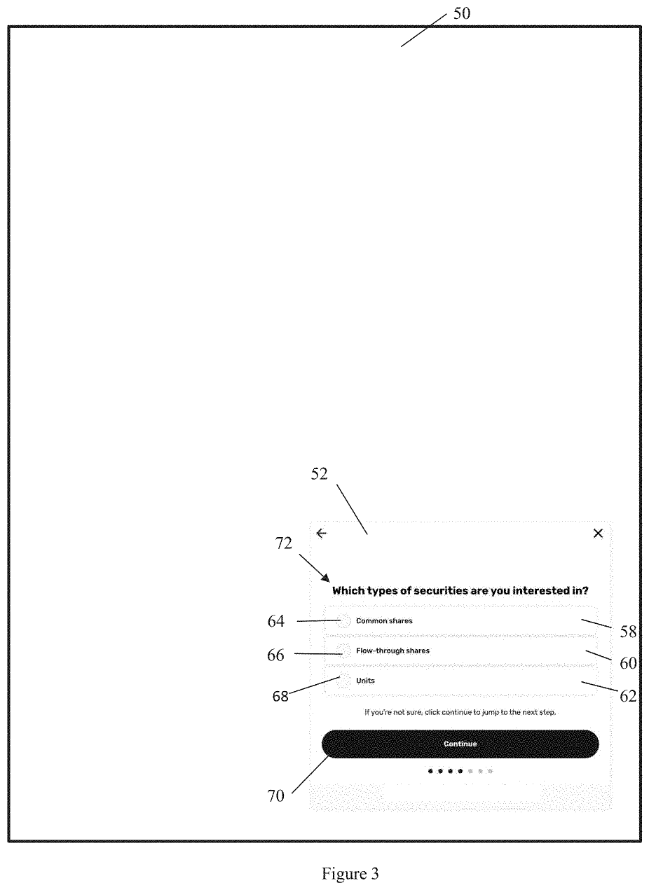

FIG. 3 illustrates the web page 50 in which the content of the interactive window is updated to inform the user of the types of securities available for purchase. In the illustrated embodiment, the interactive window 52 comprises three boxes 58, 60 and 62, each for a respective available type of security. In the illustrated embodiment, common shares, flow-through shares and units are available for purchase. Each box 58, 60 and 62 comprises a respective push button 64, 66, 68 to allow the user to select the corresponding security. The interactive window 52 further comprises a button 70 for transmitting the selected choices of securities, and text 72 informing the user to select desired types of securities.

Once the updated interactive window is displayed to the user, the user may select at least one desired security type in which he is interested. For example, the user may select “common shares” by clicking on the push button 64 contained in the box 58, and “units” by clicking on the push button 68 contained in the box 62.

The identification of the selected types of securities is then sent from the computer to the issuer server over the telecommunication network.

At step 18, the selected types of securities are received by the issuer server.

Following the reception of the selected types of securities, the user is requested to select an amount of financial resources (e.g., an amount of money) to be invested at step 20. In one embodiment, only the interactive window is modified within the web page displayed to the user. In this case, only the information contained within the interactive window is updated by the server issuer to request the user to input an amount of money for investment. In another embodiment, the whole web page is modified, i.e. a new web page comprising the interactive window is transmitted by the issuer server to the user computer over the communication network. In both cases, the interactive window requests the user to input an amount of money for investment.

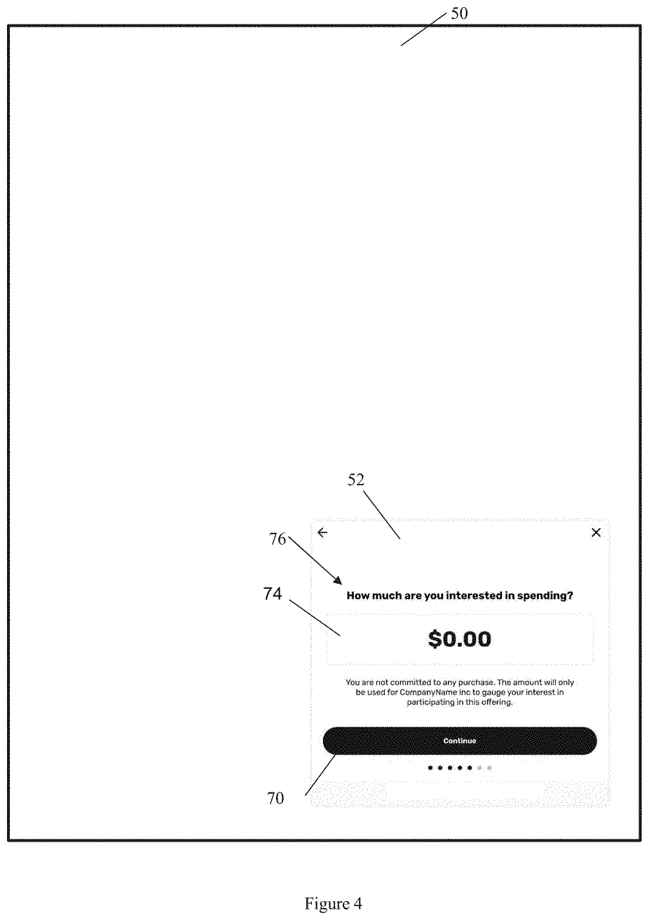

FIG. 4 illustrates the web page 50 in which the content of the interactive window 52 is updated to request the user to input an amount of financial resources to be invested. The interactive window 52 comprises a text box 74 in which the user may input an amount of money to be invested. In the illustrated example, a predefined amount of money equal to $0.00 is displayed in the text box 74. The interactive window 52 further comprises a button 70 for transmitting the specified amount of financial resources to be invested and text 76 informing the user to specify the amount of financial resource to be invested.

Once the updated interactive window is displayed to the user, the user may input a desired amount of money for investment in the box 74. For example, by clicking on the text box 40 and typing “1000”, the user may change the number from $0.00 to $1,000,00. The person skilled in the art will understand that the number representing the amount must be at least $0.00.

The identification of the selected amount of financial resources to be invested is then sent from the computer to the issuer server over the telecommunication.

At step 22, the selected amount of financial resources to be invested received by the issuer server.

Following the reception of the specified amount of financial resources to be invested, the user is requested to type his contact information at step 24. In one embodiment, only the interactive window is modified within the web page displayed to the user. In this case, only the information contained within the interactive window is updated to request contact information from the user. In another embodiment, the whole web page is modified, i.e. a new web page comprising the interactive window is transmitted by the issuer server to the user computer over the communication network. In both cases, a request for contact information is contained in the interactive window.

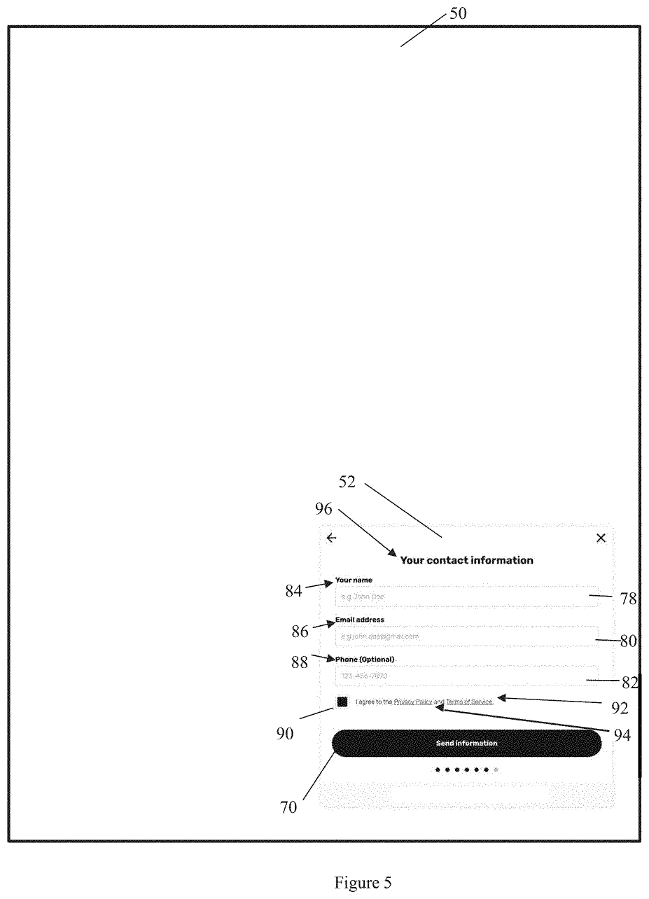

FIG. 5 illustrates the web page 50 in which the content of the interactive window (52) is updated to request the user to input contact information. In the illustrated embodiment, the interactive window 52 comprises three text boxes 78, 80 and 82, each for inputting a respective information to be provided. In the illustrated embodiment, the user's name and email address are required to be provided and the user's phone number may be optionally input. The text box 78 is to be used by the user to input his name, the text box 80 is to be used to input his email address while the text box 82 may be used to input a phone number. A respective text 84, 86, 88 informing the user about the type of requested information is further associated with each text box 74, 76, 78. The interactive window 52 further comprises a checkbox 90 and links 92, 94 to web pages of the website of the issuer containing the privacy policy and terms of service. The checkbox 90 may be actuated by the user to signify that he agrees to both the privacy policy and terms of service. Inside the interactive window 52 is also comprised. The interactive window 52 further comprises a button 70 for transmitting the inputted information, and text 96 informing the user to provide contact information.

Once the updated interactive window is displayed to the user, the user may type the contact information required. For example, the user may type “John Doe” after clicking on the text area contained in the box 78, and “john.doe@gmail.com” after clicking on the text area contained in the box 80. The user may also first click on the links 90 and 94 to have access to the privacy policy and terms of service and, second, click on the checkbox 90 to confirm that he accepts both privacy policy and term of service.

The inputted information is then sent from the computer to the issuer server over the telecommunication network.

At step 26, the inputted information is received by the issuer server.

At step 28, the collected information, i.e. the user information, the selected types of securities and the amount of money for investment, is transmitted to an analyzer server over the communication network, or internally if the analyzer server shares the hardware resources of the analyzer server. In one embodiment, the collected information may be grouped into an information package and the information package is transmitted to the analyzer server. The analyzer server is configured for receiving and analyzing the collected information to determine whether the collected information is compliant with predefined rules. For example, the predefined rules may define types of required or mandatory information, minimal and/or maximal amount of money for types of securities, and/or the like. The analyzer server may then determine that a given piece of information about the user, such as an email address in the event the user did not input his email address, is missing, that an amount of money inputted by the user is not within the range of allowed amounts of money specified by the issuer, that an amount of money input by the user for a given type of securities is not within the range of allowed amounts of money specified by the issuer for the given type of securities, etc. The analyzer server is further configured for transmitting the results of the analysis over the communication network. If it determines that all collected information is compliant with the predefined rules, the analyzer server transmits a message indicative of a positive result to the issuer. If it determines that at least some of all collected information is not compliant with the predefined rules, the analyzer server transmits a message indicative of a negative result. In this case, the analyzer server may further be configured for transmitting an indication of the type of information that is not compliant. For example, in the event the user did not provide his email address or provided an incorrect email address (such as an email address comprises no @), the analyzer server may transmit a message indicative that the email address is missing. In another example in which the amount of money for investment specified by the user is not within a predefined range, the analyzer server may transmit a message indicative that the specified amount of money is too high or too low.

At step 30, the result of the analysis of the collected information is received by the issuer server.

Depending on whether or not the collected information is compliant with the predefined rules, at step 32, the issuer server will either decide to restart the information collection or proceed with the transmission of a confirmation message informing the user that the process is complete at step 34.

In an embodiment in which the message received from the analyzer server indicates a positive analysis result, the method 10 further comprises a confirmation step, i.e. the interactive window is updated to display a confirmation message informing the user that the process is complete. In one embodiment, only the interactive window is modified within the web page displayed to the user. In this case, only the information contained within the interactive window is updated. In another embodiment, the whole web page is modified, i.e. a new web page comprising the interactive window is transmitted by the issuer server to the user computer over the communication network. In both cases, server the confirmation message is contained in the interactive window.

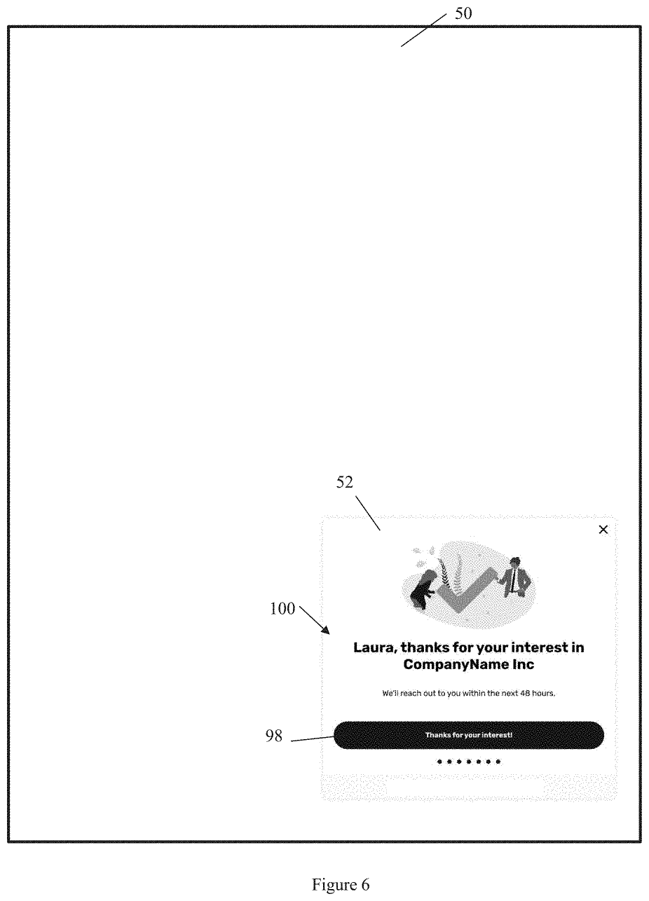

FIG. 6 illustrates the web page 50 in which the content of the interactive window 52 is updated to notify the user that the process is complete. In the illustrated embodiment, the interactive window 52 comprises a button 98 for closing the interactive window within the web page, and text 100 informing the user that the process is complete and he will be contacted, for example.

In an embodiment in which the message received from the analyzer server indicates a negative analysis result, the process of information collection is repeated, i.e. steps 16-32 are repeated. Alternatively, only the step(s) used for collecting the missing or incorrect information may be repeated. For example, if the message received for the analyzer server indicates that the email address is missing, only steps 24-32 may be repeated.

It should be understood that the order of steps 16-26 is exemplary only. For example, while in the illustrated embodiment, step 16 is executed prior to step 24, it should be understood that step 24 may be executed prior to step 16.

In one embodiment, step 18 may be omitted. While the user is presented with different types of securities for selection, the user may select none of the types of securities. Referring back to FIG. 3, the user may select none of the boxes 64, 66 and 68 and simply click on the button 70.

In one embodiment, following the reception of the confirmation of the interest of the user to invest and before the user be requested to select a type of securities, the user may be informed that the transferred collected information will be protected. To do so, the issuer server transmits to the computer of the user a message indicating that the user collected information is protected. In one embodiment, only the interactive window is modified within the web page displayed to the user. In this case, only the information contained within the interactive window is updated. In another embodiment, the whole web page is modified, i.e. a new web page comprising the interactive window is transmitted by the issuer server to the user computer over the communication network. In both cases, the message indicating that the user collected information is protected is contained in the interactive window.

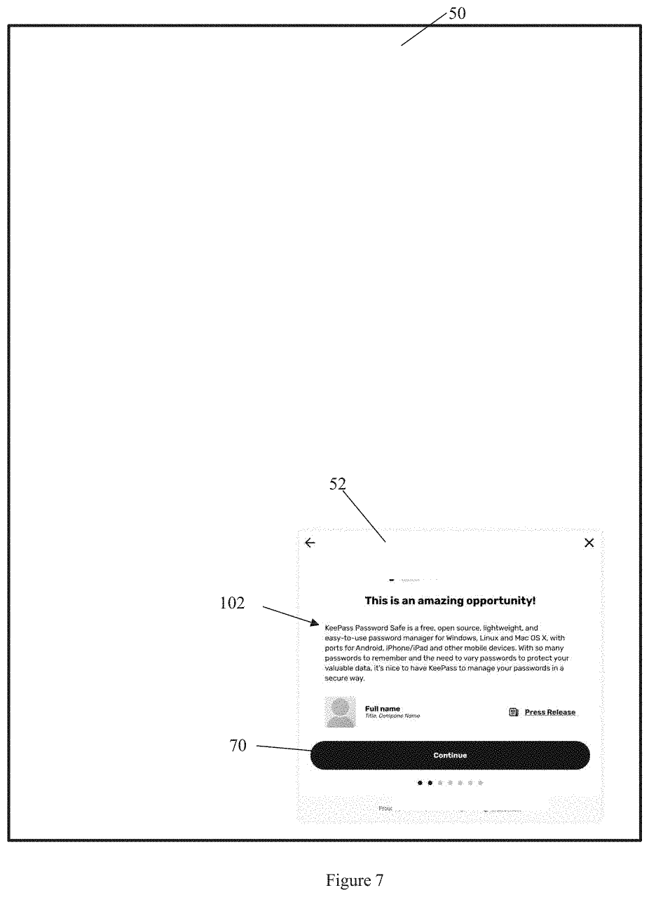

FIG. 7 illustrates the web page 50 in which the content of the interactive window 52 is updated to notify the user that the collected information is protected. In the illustrated embodiment, the interactive window 52 comprises a button 70 for transmitting to the issuer server a message indicating that the user acknowledged the information contained with the interactive window 52, and text 102 informing the user that his collected information will be protected.

In one embodiment following the reception of the confirmation of the interest of the user to invest and before the user is requested to select a type of security, the user may be informed that he will not commit to any purchase by responding the questions. To do so, the issuer server transmits to the computer of the user a message indicating that the user is not committed to any purchase. In one embodiment, only the interactive window is modified within the web page displayed to the user. In this case, only the information contained within the interactive window is updated. In another embodiment, the whole web page is modified, i.e. a new web page comprising the interactive window is transmitted by the issuer server to the user computer over the communication network. In both cases, the message indicating that the user is not committed to any purchase is contained in the interactive window.

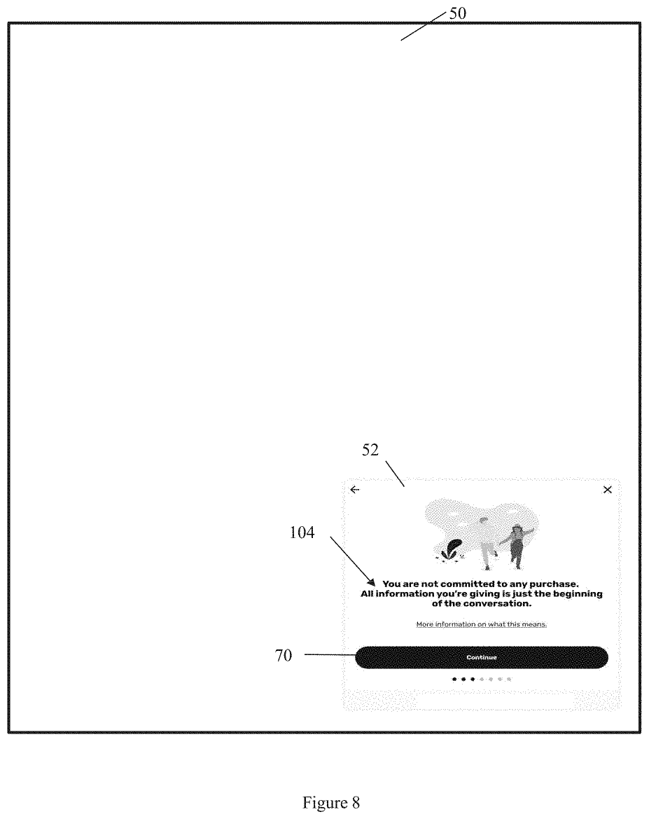

FIG. 8 illustrates the web page 50 in which the content of the interactive window (52) is updated to notify the user that he will not be committed to any purchase. In the illustrated embodiment, the interactive window 52 comprises a button 70 for transmitting to the issuer server a message indicating that the user acknowledged the information contained with the interactive window 52, and text 104 informing the user that he will not be committed to any purchase.

While the interactive window is provided with a rectangular shape in the illustrated embodiments of FIGS. 2-8, the person skilled in the art would understand that the interactive window may be provided with any other adequate shape. For example, the interactive window may have a circular shape, a pentagonal shape or the shape of a shield.

While in the illustrated embodiments, the interactive window is located at the bottom right of the web page, the person skilled in the art would understand that the interactive window could be located at any adequate position within the web page. For example, the interactive window may be located at the top right of the web page.

In one embodiment, the interactive window (except for the interactive window displayed at step 12) is provided with an arrow button located at the top left thereof for example. The arrow button may be used by the user to return to a previous interactive window. Upon actuation of the arrow, the user computer sends a signal to the issuer server indicating that the user wishes to go back to the previous form of the interactive window. In response, the issuer server transmits to the computer of the user the previous interactive window.

In one embodiment, the interactive window is provided with a cross button located at the top right thereof for example. The cross button may be activated to close the interactive window.

In the following there is described one embodiment of a system for executing the method 10.

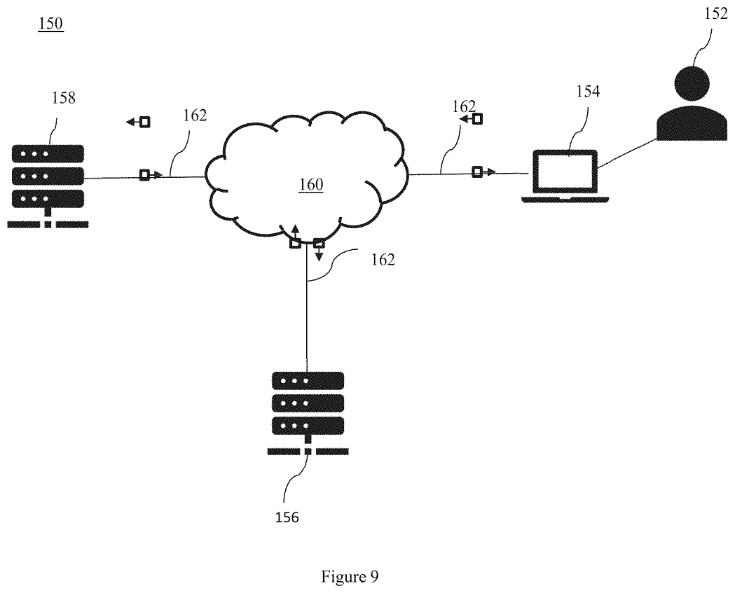

Referring to FIG. 9, there is shown a schematic diagram of a communication system 150, which will be referred to as the system 150, the system 150 being suitable for implementing one or more non-limiting embodiments of the present technology. It is to be expressly understood that the system 150 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 150 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 150 may provide in certain instances simple implementations of the present technology, and that where such is the case they have been presented in this manner as an aid to understanding. As persons skilled in the art would understand, various implementations of the present technology may be of a greater complexity.

The system 150 comprises a user computer 154 associated with a user 152, an issuer server 156, and an analyzer server 158 communicatively coupled over a communications network 160. The issuer server 156 is configured for inserting/embedding an interactive widow into a web page that is displayed to the user 152 in order to collect information related to an opportunity of investment. The user 152 responds to the questions displayed in the interactive window using the computer 154. The analyzer server 158 is configured for analyzing the information collected by the issuer server 156 according to a set of predefined rules and transmitting the results of the analysis to the issuer server 156.

The system 150 comprises a user computer 154. The user computer is associated with the user 152. As such, the user computer 154 can sometimes be referred to as a “electronic device”, “end user device” or “client electronic device”. It should be noted that the fact that the user computer 154 is associated with the user 152 does not need to suggest or imply any mode of operation—such as a need to log in, a need to be registered, or the like

The user computer 154 comprises one or more components of an electronic device such as one or more single or multi-core processors collectively represented by a processor, graphics processing unit (GPU), a solid-state drive, a random access memory, a display, and an input/output interface.

The issuer server 156 is configured to collect information from the user via an interactive window inserted into a web page and transmit the collected information to the analyzer server 158. More specifically the issuer server 156 is configured to: (i) request, via the interactive window, the user 152 to signal his interest in the investment, according to step 12 of the method 10; (ii) receive confirmation of the interest of the user 152 in receiving information about the investment or funding opportunity/offer offered by the issuer, according to step 14; (iii) request, via the interactive window, the user 152 to select at least one type of security_{;} according to step 16; (iv) optionally receive the selected type of security from the computer 154 of the user 152, according to step 18; (v) request, via the interactive window, the user 152 to select an amount of money for investment, according to step 20; (vi) receive the amount of money to invest from the computer 154 of the user 152, according to step 22; (vii) request, via the interactive window, the user 152 to provide personal information, according to step 24; (viii) receive the user personal information from the computer 154 of the user 152, according to step 26; (ix) transmit the collected information to the analyzer server 158, according to step 28; (x) receive, from the analyzer server 158, analysis results indicating whether the collected information provided by the user 152 is compliant with predefined rules, according to step 20; (xi) determine based on the analysis results whether the collection of information from the user is complete, according to step 12; and (xii) transmit to the user computer 154 confirmation that the process is complete, according to step 34.

It will be appreciated that the issuer server 156 can be implemented as a conventional computer server and may comprise at least some of the features of the electronic device. In a non-limiting example of one or more embodiments of the present technology, the issuer server 156 is implemented as a server running an operating system (OS). The issuer server 156 may be implemented in any suitable hardware and/or software and/or firmware or a combination thereof. In the disclosed nonlimiting embodiment of present technology, the issuer server 156 is a single server. In one or more alternative non-limiting embodiments of the present technology, the functionality of the issuer server 156 may be distributed and may be implemented via multiple servers (not shown).

The implementation of the issuer server 156 is well known to the person skilled in the art. However, the issuer server 156 comprises a communication interface (not shown) configured to communicate with various entities (such as the analyzer server 158, for example and other devices potentially coupled to the communication network 160) via the communication network 160. The issuer server 156 further comprises at least one computer processor (e.g., the processor of the electronic device) operationally connected with the communication interface and structured and configured to execute various processes to be described herein.

The analyzer server 158 is configured to: (i) receive the collected information provided by the user 152 from the issuer server 156, according to step 28 of method 10; (ii) analyze the received information to determine whether the received information is compliant with predefined rules; and (iii) transmit to the issuer server 156 the result of the analysis, according to step 30.

It will be appreciated that the analyzer server 158 can be implemented as a conventional computer server and may comprise at least some of the features of the electronic device. In a non-limiting example of one or more embodiments of the present technology, the analyzer server 158 is implemented as a server running an operating system (OS). The analyzer server 158 may be implemented in any suitable hardware and/or software and/or firmware or a combination thereof. In the disclosed nonlimiting embodiment of present technology, the analyzer server 158 is a single server. In one or more alternative non-limiting embodiments of the present technology, the functionality of the analyzer server 158 may be distributed and may be implemented via multiple servers (not shown).

The implementation of the analyzer server 158 is well known to the person skilled in the art. However, the analyzer server 158 comprises a communication interface (not shown) configured to communicate with various entities (such as the issuer server 156, for example and other devices potentially coupled to the communication network 160) via the communication network 160. The analyzer server 158 further comprises at least one computer processor (e.g., the processor of the electronic device) operationally connected with the communication interface and structured and configured to execute various processes to be described herein.

In one or more embodiments of the present technology, the communications network 160 is the Internet. In one or more alternative non-limiting embodiments, the communication network 160 may be implemented as any suitable local area network (LAN), wide area network (WAN), a private communication network or the like. It will be appreciated that implementations for the communication network 160 are for illustration purposes only. How a communication link 162 (not separately numbered) between the user computer 154, the issuer server 156, the analyzer server 158, and/or another electronic device (not shown) and the communications network 160 is implemented will depend inter alia on how each electronic device is implemented.

The communication network 160 may be used in order to transmit data packets amongst the user computer 154, the issuer server 156 and the analyzer server 208.

In one embodiment, the interactive window is generated by embedding code such as Javascript™ code in the web page, In another embodiment, the interactive window is generated via a widget for website builders such Wordpress™. However, it should be understood that any adequate method for embedding an interactive window in a web page may be used.

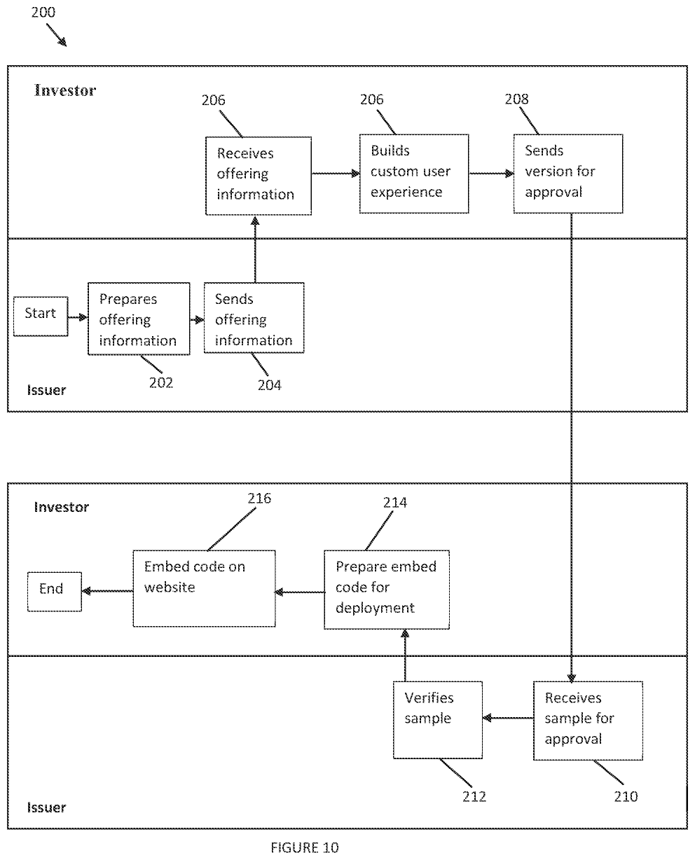

FIG. 10 illustrates one embodiment of a method 200 for designing and embedding an interactive window into a web page to collect information about potential investors.

At step 202, an issuer looking for potential investors prepares offering information related to the offer for investment he proposes. The offering information may comprise the size of the offering, the types of securities, press release links, product choices such as colors, language, contact information and photos such as a company logo and headshots of representatives.

At step 204, the offering information is transmitted to a service provider, i.e. the company operating the analyzer server.

Upon reception of the offering information at step 206, the service provider builds a custom interactive window sample, hereinafter referred to as the sample, to provide the issuer with a custom user experience, at step 208. Once built, the sample is transmitted to the issuer for review at step 210.

At step 212, the issuer receives the sample from the service provider for approval. Following review and approval of the sample by the issuer at step 214, the service provider prepares an embed code at step 216. Once it has been prepared, the embed code is installed on the website of the issuer at step 218.

In one embodiment, the review of the sample by the issuer is based on aesthetic criteria, practical criteria or personal impressions.

It should be understood that the several samples may be created before arriving at a final sample approved by the issuer and/or several revisions of a same sample or of different samples may be performed.

After the compliant information is provided to the issuer, which may be done via the issuer server, the issuer reviews the information and determines whether to approve the sale of securities to the user. The issuer further determines whether to provide the securities directly to the user from the issuer's treasury, or to redirect the user to a website to purchase the securities via an exchange, such as a stock exchange for common or preferred shares of the issuer. If the issuer determines that the user should purchase the securities from the company's treasury, then upon confirmation by the user and generally after receiving the agreed amount of money from the user, the issuer obtains the securities on behalf of the user from the company treasury, and transmits confirmation of the purchase to the user. The described assessment and purchase may be automated by a computer system in whole or in part.

If the user is redirected to an exchange, the purchase may be handled by third party software or via a brokerage website. While the issuer does not participate in this purchase, the issuer does gain knowledge about the user and the planned purchase, which may be useful, for example, for marketing purposes.

While an exchange, as the term is used herein, includes traditional exchanges, such as stock and options exchanges, it also includes non-traditional exchanges that facilitate the purchase of non-traditional securities by a buyer from a seller, such as the Ethereum™ network. Such non-traditional securities may include, for example cryptocurrencies and non-fungible tokens (NFTs). Such non-traditional securities may be created, or issued, by an issuer, as that term is used herein. Such non-traditional exchanges and securities are intended to be within the scope of this invention.

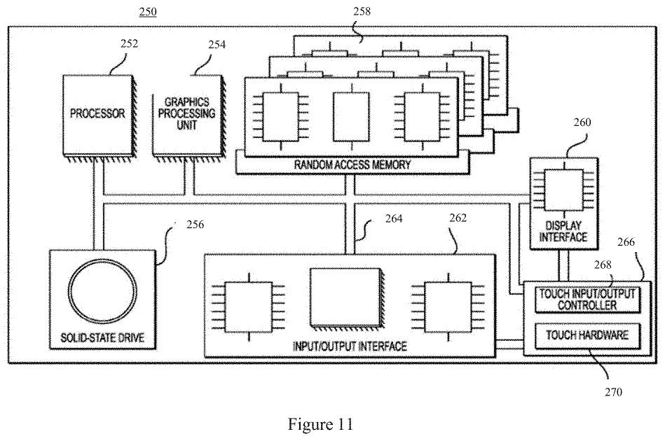

Referring to FIG. 11, there is shown an electronic device 250 suitable for use with some implementations of the present technology, the electronic device 250 comprising various hardware components including one or more single or multi-core processors collectively represented by processor 252, a graphics processing unit (GPU) 254, a solid-state drive 256, a random access memory 258, a display interface 260, and an input/output interface 262. For example, the electronic device may be used as computer 154, issuer server 156 or analyzer server 158.

Communication between the various components of the electronic device 250 may be enabled by one or more internal and/or external buses 264 (e.g. a PCI bus, universal serial bus, IEEE 1394 “Firewire” bus, SCSI bus, Serial-ATA bus, etc.), to which the various hardware components are electronically coupled.

The input/output interface 262 may be coupled to a touchscreen 166 and/or to the one or more internal and/or external buses 264. The touchscreen 266 may be part of the display. In one or more embodiments, the touchscreen 266 is the display. The touchscreen 266 may equally be referred to as a screen 266. In the embodiments illustrated in FIG. 10, the touchscreen 266 comprises touch hardware 270 (e.g., pressure-sensitive cells embedded in a layer of a display allowing detection of a physical interaction between a user and the display) and a touch input/output controller 268 allowing communication with the display interface 260 and/or the one or more internal and/or external buses 264 In one or more embodiments, the input/output interface 262 may be connected to a keyboard (not shown), a mouse (not shown) or a trackpad (not shown) allowing the user to interact with the electronic device 250 in addition or in replacement of the touchscreen 266.

According to implementations of the present technology, the solid-state drive 256 stores program instructions suitable for being loaded into the random-access memory 258 and executed by the processor 252 and/or the GPU 254. For example, the program instructions may be part of a library or an application.

The electronic device 250 may be implemented as a server, a desktop computer, a laptop computer, a tablet, a smartphone, a personal digital assistant or any device that may be configured to implement the present technology, as it may be understood by a person skilled in the art.

In one embodiment, the above-described method and system provide an infrastructure comprised of web-services, front-end components and data models with a focus on user experience. The system allows for deployment, configuration and customization solutions for business cases related multiple workflows for issuer companies releasing a funding offering. The issuer company may manage offering details, customize the user experience and utilize a dashboard to manage the submissions in real-time.

In one embodiment, the widget or the embed code enabling the generation of the embedded interactive window is built for cross-communication, thereby allowing issuer companies to increase interest in raising capital by embedding a communication tool on their website. Issuer companies may place the embed code or the widget within any web environment without affecting the integrity or security of their systems.

In one embodiment, the widget or the embed code enabling the generation of the embedded interactive window can be removed and restored by the issuer at anytime.

The embodiments of the invention described above are intended to be exemplary only. The scope of the invention is therefore intended to be limited solely by the scope of the appended claims.

What is claimed is:

1. A computer-implemented method for purchasing securities issued by an issuer by collecting information from a user via an interactive window embedded into a web page, the method comprising:
providing a web page for display on a user display unit, the web page comprising an interactive window displaying a first message informing the user of an investment opportunity to purchase securities issued by the issuer;
receiving, from the user, a confirmation of interest in the investment opportunity;
updating the interactive window to display a second message requesting the user to select a type of securities that the user wishes to purchase;
receiving, from the user, a selection of the type of securities that the user wishes to purchase;
updating the interactive window to display a third message requesting the user to input a desired amount of financial resources to invest;
receiving, from the user, an indication of the desired amount of financial resources;
updating the interactive window to display a fourth message requesting the user to input user information identifying the user and specifying a method of payment;
receiving the user information;
transmitting at least the received indication of the desired amount of financial resources, the selected type of securities, and the user information to an analyzer server, the analyzer server being configured for information verification;
receiving from the analyzer server a confirmation of information compliance;
sending at least the indication of the desired amount of financial resources, the selected type of securities, and the user information to the issuer via an electronic network;
determining, by the issuer, whether to redirect the user to purchase the securities from an exchange or sell the securities directly, by the issuer, to the user; and
either (a) obtaining the securities on behalf of the user, by the issuer, from the issuer's treasury, and informing the user that the securities have been purchased, or (b) redirecting the user to a website configured to permit the user to purchase the securities via the exchange.

2. The method of claim 1, wherein the determining, obtaining and informing steps are performed by a computer system of the issuer and the user is informed of the purchase via the communications network The method of claim 1, wherein the exchange is a stock exchange.

4. The method of claim 1, wherein the exchange is the Ethereum™ network.

5. The method of claim 1 wherein the selected type of securities is common shares of the issuer.

6. The method of claim 1, wherein the selected type of securities is non-fungible tokens.

7. A system for collecting information via a web page, the system comprising:
an issuer server configured to generate a web page, the issuer server being further configured to:
provide a web page for display on a user display unit, the web page displaying a first message informing the user of an investment opportunity;
receive, via the web page, from the user, a confirmation of interest in the investment opportunity, a selection of at least one type of securities, an indication of the desired amount of financial resources to invest, and user information comprising contact information and payment information;
transmit the information received from the user to an analyzer server configured to determine whether the information received from the user is compliant with a set of predefined rules, thereby obtaining an analysis result; and
transmit the analysis result to the issuer server,
wherein the issuer server is further configured to update the web page to display a second message informing the user that collection of information is complete when the analysis result indicates that the user indication is compliant with the set of predefined rules.

8. The system of claim 7, wherein the issuer determines whether to redirect the user to a website configured to permit the user to purchase the securities via an exchange, or to sell the securities directly to the user.

9. The system of claim 7, wherein the analyzer server, on behalf of the issuer, determines whether to redirect the user to a website configured to permit the user to purchase the securities via an exchange, or to sell the securities directly to the user, and either obtains the securities on behalf of the user from the issuer's treasury, and informs the user that the securities have been purchased, or redirects the user to a website configured to permit the user to purchase the securities via an exchange.

10. A computer-implemented method for collecting information via an interactive window embedded into a web page, the method comprising:
providing a web page for display on a user display unit, the web page comprising an interactive window displaying a first message informing the user of an investment opportunity;
updating the interactive window to display a second message requesting the user to select at least one type of securities;
updating the interactive window to display a third message requesting the user to input an indication of a desired amount of financial resources to invest;
receiving the indication of the desired amount of financial resources;
updating the interactive window to display a fourth message requesting the user to input user information;
receiving the user information;
transmitting at least the indication of the received desired amount of financial resources and the received user information to an analyzer server being configured for information verification;
receiving from the analyzer a confirmation of information compliance;
updating the interactive window for displaying a fifth message informing the user that a collection of information is complete;
sending the indication of the desired amount of financial resources, the selected type of securities, and the user information to the issuer via a communications network; and
determining whether the securities should be obtained from the issuer's treasury, and if it is determined that the securities should be obtained from the issuer's treasury, transmitting confirmation of the availability of the selected securities to the user and requesting confirmation from the user that the issuer should proceed to obtain the securities on behalf of the user.

11. The method of claim 10, further comprising the step of, if it is not determined the securities should be obtained from the issuer's treasury, redirecting the user to a website configured to permit the user to purchase the securities via an exchange.
